(19) United States
(12) Patent Application Publication
(10) Pub. No.: US 2018/0202550 A1
(43) Pub. Date: Jul. 19, 2018

(54) Planetary Powertrain Configurations With A Ball Variator Continuously Variable Transmission Used As A Powersplit

(71) Applicant: Dana Limited, Maumee, OH (US)

(72) Inventors: Kenneth E. Cooper, Toledo, OH (US); Gordon M. McIndoe, Volente, TX (US); Sebastian J. Peters, Cedar Park, TX (US)

(21) Appl. No.: 15/474,120

(22) Filed: Mar. 30, 2017

Related U.S. Application Data
(60) Provisional application No. 62/316,703, filed on Apr. 1, 2016.
(60) Provisional application No. 62/318,395, filed on Apr. 5, 2016.

(51) Int. Cl. F16H 61/664; F16H 63/06; F16H 63/42; F16H 59/40; F16H 15/50; F16H 25/22; F16H 37/04

(52) U.S. Cl. CPC F16H 61/6645; F16H 63/067; F16H 63/42; F16H 2045/0215; F16H 15/506; F16H 25/229; F16H 37/042; F16H 59/40

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having an array of balls, a planetary gearset coupled thereto and an arrangement of rotatable shafts with multiple gears and clutches that extend the ratio range of the variator. In some embodiments, clutches are coupled to the gear sets to enable synchronous shifting of gear modes.

### RELATED APPLICATION

The present application claims the benefit of U.S. Provisional Application No. 62/316,703 filed on Apr. 1, 2016 and U.S. Provisional Application No. 62/318,395 filed on Apr. 5, 2016, which are incorporated herein by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission including: a first rotatable shaft operably coupleable to a source of rotational power, the first rotatable shaft forming a main axis; a variator assembly having a first traction ring assembly and a second traction ring assembly in contact with a plurality of balls, wherein each ball of the plurality of balls has a tiltable axis of rotation, the variator assembly is coaxial with the main axis; a first planetary gearset having a first sun gear, a first planet carrier operably coupled to the first rotatable shaft, and a first ring gear coupled to the second traction ring assembly; a first gear set operably coupled to the first traction ring assembly; a second gear set operably coupled to the first sun gear, the second gear set operably coupled to the first gear set; and a third gear set operably coupled to the second traction ring assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a planetary powersplit continuously variable transmission.

FIG. 5 is a schematic diagram of a multiple mode continuously variable transmission having the planetary powersplit continuously variable transmission of FIG. 4.

FIG. 6 is a table depicting operating modes of the continuously variable transmissions depicted in FIG. 5.

FIG. 7 is a schematic diagram of the planetary powersplit continuously variable transmission of FIG. 4 and a coupling planetary device.

FIG. 8 is a table depicting a number of powertrain configurations using the powersplit continuously variable transmission and the coupling planetary device of FIG. 7.

FIG. 9 is a schematic diagram of a multiple mode continuously variable transmission having a continuously variable transmission.

FIG. 10 is a table depicting operating modes of the continuously variable transmission depicted in FIG. 9.

FIG. 11 is a schematic diagram of a multiple mode continuously variable transmission having the planetary powersplit continuously variable transmission.

FIG. 12 is a table depicting operating modes of the continuously variable transmissions depicted in FIG. 11.

FIG. 13 is a schematic diagram of another multiple mode continuously variable transmission having the planetary powersplit continuously variable transmission.

FIG. 14 is a table depicting operating modes of the continuously variable transmissions depicted in FIG. 13.

FIG. 15 is a schematic diagram of a planetary powersplit continuously variable transmission having a ravigneaux gear set.

FIG. 16 is a schematic diagram of another planetary powersplit continuously variable transmission having a ravigneaux gear set.

FIG. 17 is a schematic diagram of yet another planetary powersplit continuously variable transmission having a ravigneaux gear set.

FIG. 18 is a schematic diagram of yet another planetary powersplit continuously variable transmission having a ravigneaux gear set.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

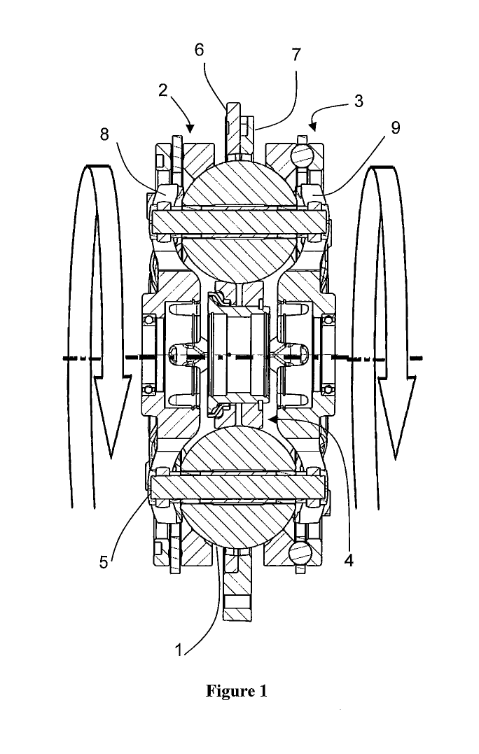

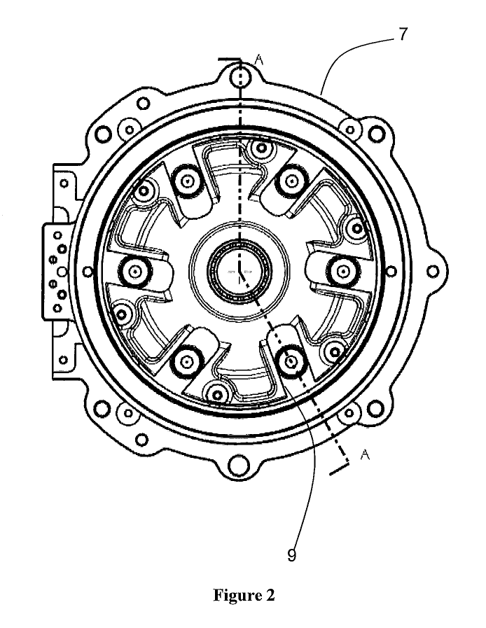

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

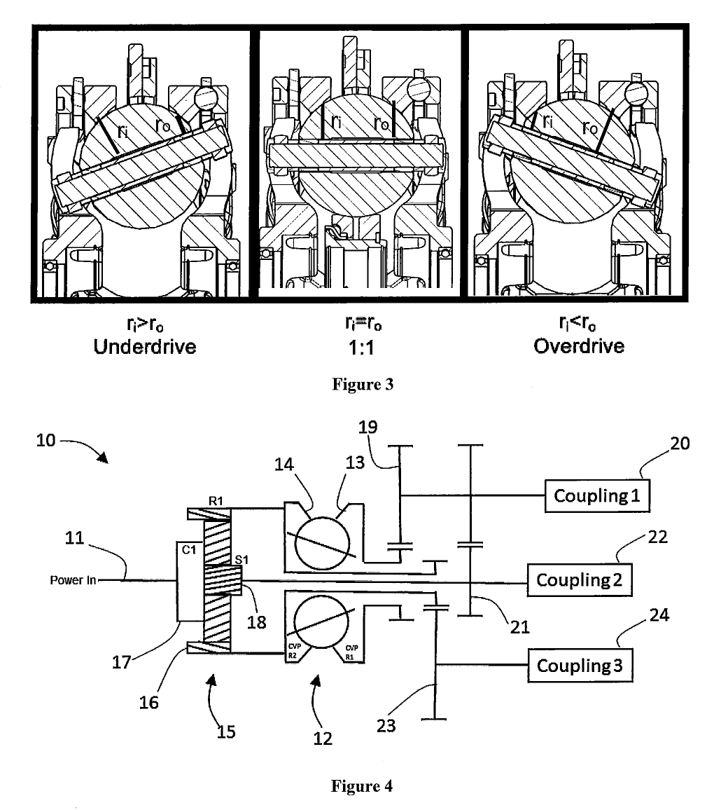

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

Referring now to FIG. 4, in some embodiments, a continuously variable transmission (CVT) 10 is provided with a first rotatable shaft 11 adapted to receive power from a source of rotational power. In some embodiments, the first rotatable shaft 11 is operably coupled to a torque converter device, or other common coupling. The CVT 10 is provided with a variator (CVP) 12 aligned coaxially with the first rotatable shaft 11. In some embodiments, the variator 12 is similar to the variator depicted in FIGS. 1-3. The variator 12 includes a first traction ring assembly 13 and a second traction ring assembly 14 in contact with a number of balls. In some embodiments, the CVT 10 includes a planetary gear set 15 aligned coaxially with the first rotatable shaft 11 and the variator 12. The planetary gear set 15 includes a ring gear 16, a planet carrier 17, and a sun gear 18. In some embodiments, the planet carrier 17 is coupled to the first rotatable shaft 11. The ring gear 16 is coupled to the second traction ring assembly 14. In some embodiments, the CVT 10 has a first gear set 19 operably coupled to the first traction ring assembly 13. The first gear set 19 is configured to provide a power output path through a first coupling device 20. In some embodiments, the CVT 10 has a second gear set 21 operably coupled to the sun gear 18 and the first gear set 19. The second gear set 21 is configured to provide a power output path through a second coupling device 22. In some embodiments, the CVT 10 has a third gear set 23 operably coupled to the second traction ring assembly 14. The third gear set 21 is configured to provide a power output path through a third coupling device 24. It should be appreciated that the first coupling device 20, the second coupling device 22, and the third coupling device 23 are optionally configured by a designer to achieve desired performance and packaging of the continuously variable transmission.

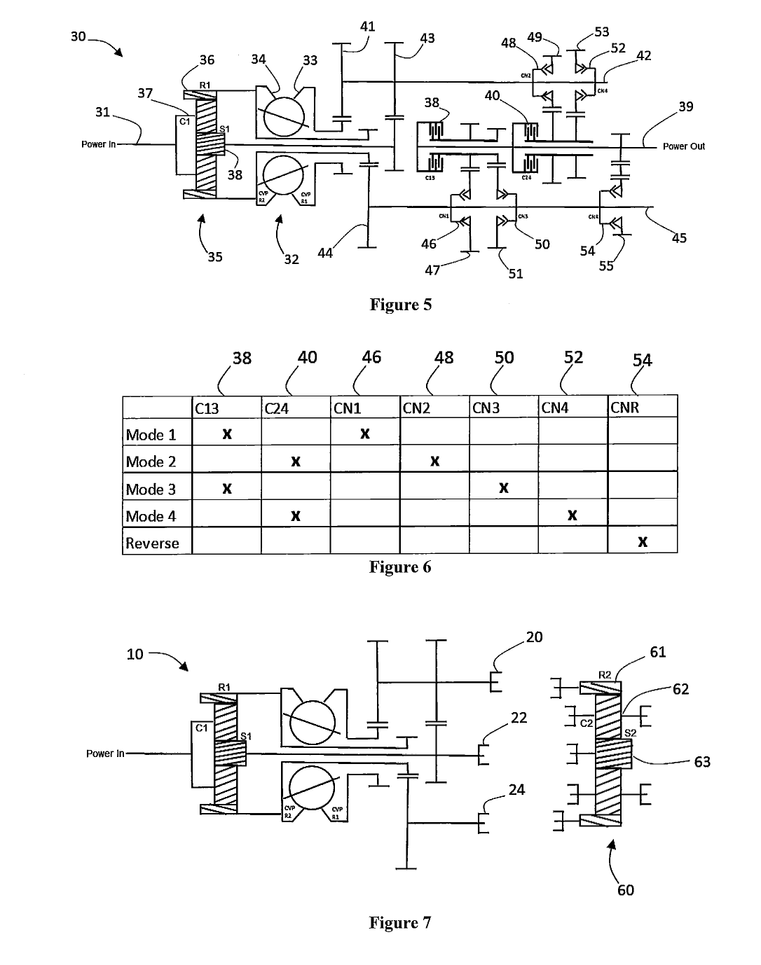

Turning now to FIG. 5, in some embodiments a continuously variable transmission (CVT) 30 provided with a first rotatable shaft 31 adapted to receive power from a source of rotational power. In some embodiments, the first rotatable shaft 31 is operably coupled to a torque converter device, or other common coupling. The CVT 30 is provided with a variator (CVP) 32 aligned coaxially with the first rotatable shaft 31. In some embodiments, the variator 32 is similar to the variator depicted in FIGS. 1-3. The variator 32 includes a first traction ring assembly 33 and a second traction ring assembly 34 in contact with a number of balls. In some embodiments, the CVT 30 includes a planetary gear set 35 aligned coaxially with the first rotatable shaft 31 and the variator 32. The planetary gear set 35 includes a ring gear 36, a planet carrier 37, and a sun gear 38. In some embodiments, the planet carrier 17 is coupled to the first rotatable shaft 11. The ring gear 36 is coupled to the second traction ring assembly 34.

Still referring to FIG. 5, in some embodiments, the CVT 30 includes a first-and-third mode clutch 38 operably coupled to a second rotatable shaft 39. The second rotatable shaft 39 is coaxial with the first rotatable shaft 31 and forms a main axis of the CVT 30. The CVT 30 includes a second-and-fourth mode clutch 40 operably coupled to the second rotatable shaft 39. In some embodiments, the CVT 30 includes a first gear set 41 operably coupled to the first traction ring assembly 33. The first gear set 41 is coupled to a third rotatable shaft 42. The third rotatable shaft 42 is a parallel to the second rotatable shaft 39. In some embodiments, the CVT 30 includes a second gear set 43 operably coupled to the sun gear 38 and the third rotatable shaft 42. In some embodiments, the CVT 30 includes a third gear set 44 operably coupled to the second traction ring assembly 34 and a fourth rotatable shaft 45. The fourth rotatable shaft 45 is parallel to the second rotatable shaft 39 and the third rotatable shaft 42.

Still referring to FIG. 5, in some embodiments, the CVT 30 includes a first mode synchronizer clutch 46 positioned coaxially with, and coupled to, the fourth rotatable shaft 45. The first mode synchronizer clutch 46 is operably coupled to the first-and-third mode clutch 38 with a fourth gear set 47. In some embodiments, the CVT 30 includes a second mode synchronizer clutch 48 positioned coaxially with, and coupled to, the third rotatable shaft 42. The second mode synchronizer clutch 48 is operably coupled to the second-and-fourth mode clutch 40 with a fifth gear set 49. In some embodiments, the CVT 30 includes a third mode synchronizer clutch 50 positioned coaxially with, and coupled to, the fourth rotatable shaft 45. The third mode synchronizer clutch 50 is operably coupled to the first-and-third mode clutch 38 with a sixth gear set 51. In some embodiments, the CVT 30 includes a fourth mode synchronizer clutch 52 positioned coaxially with, and coupled to, the third rotatable shaft 42. The fourth mode synchronizer clutch 52 is operably coupled to the second-and-fourth mode clutch 40 with a seventh gear set 53. In some embodiments, the CVT 30 includes a reverse mode synchronizer clutch 54 positioned coaxially with, and coupled to the fourth rotatable shaft 45. The reverse mode synchronizer clutch 54 is operably coupled to the second rotatable shaft 39 with a reverse gear set 55.

Typically, synchronizer mechanisms (referred to herein as “synchronizer clutch”) used in power transmissions include a dog clutch integrated with a speed-matching device such as a cone-clutch. During operation of the transmission, if the dog teeth of the dog clutch make contact with a gear, and the two parts are spinning at different speeds, the teeth will fail to engage and a loud grinding sound will be heard as they clatter together. For this reason, a synchronizer mechanism or synchronizer clutch is used, which consists of a cone clutch. Before the teeth engage, the cone clutch engages first, which brings the two rotating elements to the same speed using friction. Until synchronization occurs, the teeth are prevented from making contact. It should be appreciated that the exact design of the synchronizer clutch is within a designer's choice for satisfying packaging and performance requirements. A synchronizer clutch is optionally configured to be a two position clutch having an engaged position and a neutral (or free) position. A synchronizer clutch is optionally configured to be a three position clutch having a first engaged position, a second engaged position, and a neutral position. Embodiments disclosed herein use synchronizer clutches to enable the pre-selection of gear sets by a control system (not shown) for smooth transition between operating modes of the transmission. It should be appreciated that the powertrain configurations disclosed herein are optionally configured with other types of selectable torque transmitting devices including, and not limited to, wet clutches, dry clutches, dog clutches, and electromagnetic clutches, among others.

Referring now to FIG. 6, during operation of the CVT 30 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 30. The table depicted in FIG. 6, lists the modes of operation for the CVT 30 and indicates with an “x” the corresponding clutch engagement. For mode 1 operation, the first-and-third mode clutch 38 and the first synchronizer clutch 46 are engaged. For mode 2 operation, the second-and-fourth mode clutch 40 and the second synchronizer clutch 48 are engaged. For mode 3 operation, the first-and-third mode clutch 38 and the third synchronizer clutch 50 are engaged. For mode 4 operation, the second-and-fourth mode clutch 40 and the fourth synchronizer clutch 52 are engaged. For reverse mode operation, the reverse synchronizer clutch 54 is engaged.

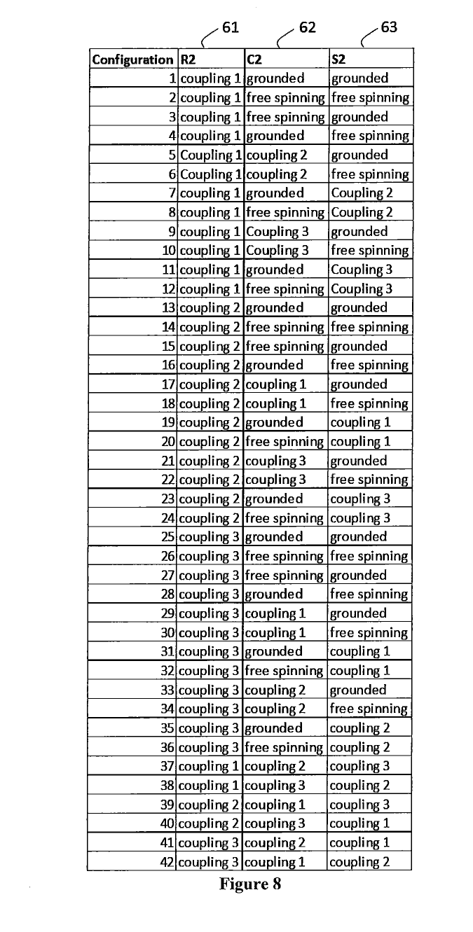

Turning now to FIGS. 7 and 8, in some embodiments, the CVT 10 is optionally configured in powertrain configurations having a coupling planetary device 60. The coupling planetary device 60 includes a second ring gear 61, a second planetary carrier 62, and a second sun gear 63. The table depicted in FIG. 8 lists optional configurations of the connections between the CVT 10 and the coupling planetary device 60. It should be noted that the term “grounded” refers to coupling of a component in a non-rotatable manner. It should be noted that the term “free spinning” refers to configuring of a component to spin freely without transfer of rotational power. It should be noted that the term “coupling 1” refers to the first coupling 20. It should be noted that the term “coupling 2” refers to the second coupling 22. It should be noted that the term “coupling 3” refers to the third coupling 24. As an illustrative example for interpreting the table of FIG. 8, in some embodiments a powertrain configuration (“configuration 1”) corresponds to connecting the second ring gear 61 to the first coupling 20, grounding the second planet carrier 62, and grounding the second sun gear 63.

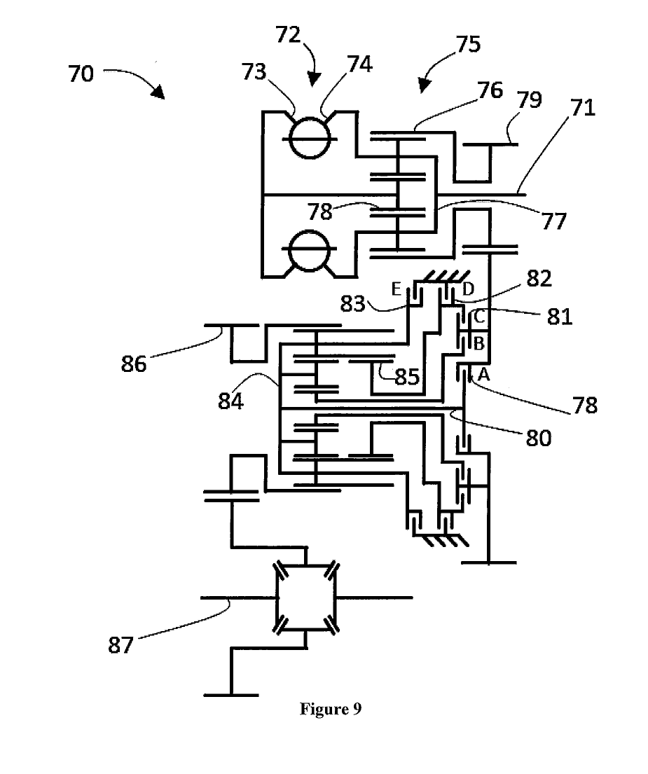

Referring now to FIG. 9, in some embodiments, a continuously variable transmission (CVT) 70 is provided with a first rotatable shaft 71 adapted to receive power from a source of rotational power. In some embodiments, the first rotatable shaft 71 is operably coupled to a torque converter device, or other common coupling. The CVT 70 is provided with a variator (CVP) 72 aligned coaxially with the first rotatable shaft 71. In some embodiments, the variator 72 is similar to the variator depicted in FIGS. 1-3. The variator 72 includes a first traction ring assembly 73 and a second traction ring assembly 74 in contact with a number of balls. In some embodiments, the CVT 70 includes a planetary gear set 75 aligned coaxially with the first rotatable shaft 71 and the variator 72. The planetary gear set 75 includes a ring gear 76, a planet carrier 77, and a sun gear 78. In some embodiments, the planet carrier 77 is coupled to the first rotatable shaft 71. The planet carrier 77 is coupled to the second traction ring assembly 74.

Still referring to FIG. 9, in some embodiments the CVT 70 is provided with a first clutch (“A”) 78 operably coupled to the ring gear 76 with a first transfer gear set 79. In some embodiments, the first transfer gear set 79 includes two meshing gears, one arranged coaxial with the first rotatable shaft 71 and another arranged coaxial with a second rotatable shaft 80. The second rotatable shaft 80 is arranged parallel to the first rotatable shaft 71. In some embodiments, the CVT 70 includes a second clutch (“B” and “C”) 81 operably coupled to the first transfer gear set 79. The second clutch 81 is configured to select between at least two positions to thereby provide at least two paths for power transfer from the first transfer gear set 79. In some embodiments, the CVT 70 includes a third clutch (“D”) 82 operably coupled to the second clutch 81. The third clutch 82 is configured to selectively couple to a grounded member of the CVT 70 such as the housing (not shown). In some embodiments, the CVT 70 includes a fourth clutch (“E”) 83 arranged coaxial with the second rotatable shaft 80. The fourth clutch 83 is configured to selectively couple to a grounded member.

Still referring to FIG. 9, in some embodiments, the CVT 70 includes a first gear set 84 having a first fixed torque ratio and a second gear set 85 having a second fixed torque ratio. The first gear set 84 and the second gear set 85 are arranged coaxial with the second rotatable shaft 80. The first gear set 84 is operably coupled to the second gear set 85. In some embodiments, the first gear set 84 is coupled to the first clutch 78, the second clutch 81, and the fourth clutch 83. The second gear set 85 is coupled to the third clutch 82. In some embodiments, the CVT 70 includes a second transfer gear set 86 coupled to the first gear set 84. The second transfer gear set 86 includes at least two meshing gears, one arranged coaxial with the second rotatable shaft 80 and another arranged coaxial with a final drive axis 87.

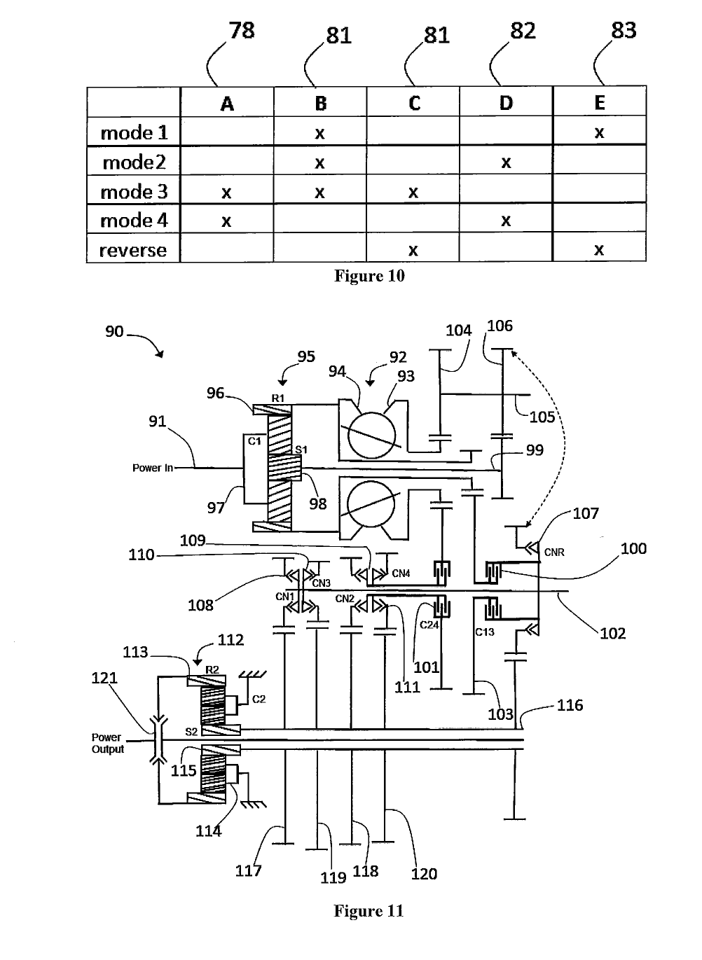

Referring now to FIG. 10, and still referring to FIG. 9, during operation of the CVT 70 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 70. The table depicted in FIG. 10, lists the modes of operation for the CVT 70 and indicates with an “x” the corresponding clutch engagement or clutch position. For mode 1 operation, the second clutch 81 is engaged in a first position (labeled as “B” in FIG. 9) and the fourth clutch 83 is engaged. For mode 2 operation, the second clutch 81 remains engaged in position B and the third clutch 82 is engaged. For mode 3 operation, the second clutch 81 engages position B and position C and the first clutch 78 is engaged. For mode 4 operation, the first clutch 78 and the third clutch 82 are engaged. For reverse mode operation, the second clutch 81 is engaged in position C and the fourth clutch 83 is engaged. Referring now to FIG. 11, in some embodiments, a continuously variable transmission (CVT) 90 is provided with a first rotatable shaft 91 adapted to receive power from a source of rotational power. In some embodiments, the first rotatable shaft 91 is operably coupled to a torque converter device, or other common coupling. The CVT 90 is provided with a variator (CVP) 92 aligned substantially coaxially with the first rotatable shaft 91. In some embodiments, the variator 92 is similar to the variator depicted in FIGS. 1-3. The variator 92 includes a first traction ring assembly 93 and a second traction ring assembly 94 in contact with a number of balls. In some embodiments, the CVT 90 includes a first planetary gear set 95 aligned coaxially with the first rotatable shaft 91 and the variator 92. The first planetary gear set 95 includes a first ring gear 96, a first planet carrier 97, and a first sun gear 98. In some embodiments, the first planet carrier 97 is coupled to the first rotatable shaft 91. The first ring gear 96 is coupled to the second traction ring assembly 94. The first sun gear 98 is coupled to a second rotatable shaft 99. The second rotatable shaft 99 is coaxial with the first rotatable shaft 91. The first rotatable shaft 91 and the second rotatable shaft 99 form a main axis of the CVT 90.

Still referring to FIG. 11, in some embodiments, the CVT 90 includes a first-and-third mode clutch 100 and a second-and-fourth mode clutch 101, each aligned on a third rotatable shaft 102. The third rotatable shaft 102 is arranged parallel to the main axis of the CVT 90. In some embodiments, the CVT 90 includes a first gear set 103 configured to couple the first-and-third mode clutch 100 to the second traction ring assembly 104. The CVT 90 includes a second gear set 104 configured to couple the second-and-fourth mode clutch 101 to the first traction ring assembly 93. In some embodiments, the second gear set 104 includes at least three meshing gears, one of which is optionally configured on a fourth rotatable shaft 105. The fourth rotatable shaft 105 is parallel to the main axis and parallel to the third rotatable shaft 102. In some embodiments, the CVT 90 includes a reverse-mode gear set 106 coupled to the fourth rotatable shaft 105 and a reverse clutch 107. The reverse clutch 107 is coaxial with the third rotatable shaft 102 and coupled to the first-and-third mode clutch 100. In some embodiments, the CVT 90 includes a first synchronizer clutch 108, a second synchronizer clutch 109, a third synchronizer clutch 110, and a fourth synchronizer clutch 111, each arranged coaxially with the third rotatable shaft 102. In some embodiments, the first synchronizer clutch 108 and the third synchronizer clutch 110 are operably coupled to the first-and-third mode clutch 100. The second synchronizer clutch 109 and the fourth synchronizer clutch 111 are operably coupled to the second-and-fourth mode clutch 101.

Still referring to FIG. 11, in some embodiments, the CVT 90 includes a second planetary gear set 112 having a second ring gear 113, a second planet carrier 114, and a second sun gear 115. In some embodiments, the second planetary gear set 112 is optionally configured as a dual pinion gear set. For example, the second planet carrier 114 supports two arrays of planet gears to the second ring gear 113 and the second sun gear 115. In some embodiments, the second sun gear 115 is a hollow sun gear to thereby allow passage of other shafts there through. In some embodiments, the second planet carrier 114 is grounded to a non-rotatable member of the CVT 90. The second planetary gear set 112 is coaxial with a fifth rotatable shaft 116. The fifth rotatable shaft 116 is parallel with the main axis and the third rotatable shaft 102. The fifth rotatable shaft 116 is coupled to the second sun gear 115. In some embodiments, the fifth rotatable shaft 116 is optionally configured as a hollow shaft. In some embodiments, the reverse gear set 106 is configured to couple to the fifth rotatable shaft 116. The CVT 90 includes a first-mode gear set 117 coupled to the first synchronizer clutch 108 and the fifth rotatable shaft 116. The CVT 90 includes a second-mode gear set 118 coupled to the second synchronizer clutch 109 and the fifth rotatable shaft 116. The CVT 90 includes a third-mode gear set 119 coupled to the third synchronizer clutch 110 and the fifth rotatable shaft 116. The CVT 90 includes a fourth-mode gear set 120 coupled to the fourth synchronizer clutch 111 and the fifth rotatable shaft 116. In some embodiments, the second ring gear 113 is coupled to a final drive gear 121. The final drive gear 121 is optionally configured as a typical differential gear.

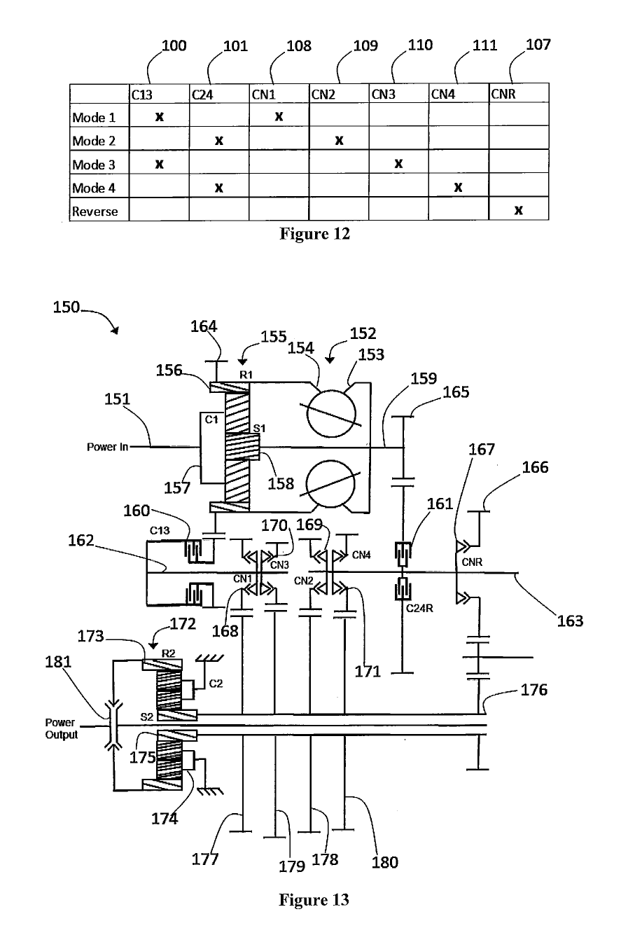

Referring now to FIG. 12, during operation of the CVT 90 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 90. The table depicted in FIG. 12, lists the modes of operation for the CVT 90 and indicates with an “x” the corresponding clutch engagement. For mode 1 operation, the first-and-third mode clutch 100 and the first synchronizer clutch 108 are engaged. For mode 2 operation, the second-and-fourth mode clutch 101 and the second synchronizer clutch 109 are engaged. For mode 3 operation, the first-and-third mode clutch 100 and the third synchronizer clutch 110 are engaged. For mode 4 operation, the second-and-fourth mode clutch 101 and the fourth synchronizer clutch 111 are engaged. For reverse mode operation, the reverse clutch 107 is engaged.

Passing now to FIG. 13, in some embodiments, a continuously variable transmission (CVT) 150 is provided with a first rotatable shaft 151 adapted to receive power from a source of rotational power. In some embodiments, the first rotatable shaft 151 is operably coupled to a torque converter device, or other common coupling. The CVT 150 is provided with a variator (CVP) 152 aligned substantially coaxially with the first rotatable shaft 151. In some embodiments, the variator 152 is similar to the variator depicted in FIGS. 1-3. The variator 152 includes a first traction ring assembly 153 and a second traction ring assembly 154 in contact with a number of balls. In some embodiments, the CVT 150 includes a first planetary gear set 155 aligned coaxially with the first rotatable shaft 151 and the variator 152. The first planetary gear set 155 includes a first ring gear 156, a first planet carrier 157, and a first sun gear 158. In some embodiments, the first planet carrier 157 is coupled to the first rotatable shaft 151. The first ring gear 156 is coupled to the second traction ring assembly 154. The first sun gear 158 is coupled to a second rotatable shaft 159. The second rotatable shaft 159 is coaxial with the first rotatable shaft 151. The first rotatable shaft 151 and the second rotatable shaft 159 form a main axis of the CVT 150.

Still referring to FIG. 13, in some embodiments, the CVT 150 includes a first-and-third mode clutch 160 arranged coaxially with and coupled to a third rotatable shaft 162. The CVT 150 includes a second-and-fourth mode clutch 161 arranged coaxially with and coupled to a fourth rotatable shaft 163. The third rotatable shaft 162 and the fourth rotatable shaft 163 are arranged parallel to the main axis of the CVT 150. In some embodiments, the CVT 150 includes a first gear set 164 configured to couple the first-and-third mode clutch 160 to the second traction ring assembly 154. In some embodiments, the first gear set 164 is coupled to the first ring gear 156. The CVT 150 includes a second gear set 165 configured to couple the second-and-fourth mode clutch 161 to the first traction ring assembly 153. In some embodiments, the CVT 150 includes a reverse-mode gear set 166 coupled to the fourth rotatable shaft 163 and a reverse clutch 167. The reverse clutch 167 is coaxial with and coupled to the fourth rotatable shaft 163. In some embodiments, the CVT 150 includes a first synchronizer clutch 168, a second synchronizer clutch 169, a third synchronizer clutch 170, and a fourth synchronizer clutch 171. The first synchronizer clutch 168 and the third synchronizer clutch 170 are arranged coaxial with and coupled to the third rotatable shaft 162. The second synchronizer clutch 169 and the fourth synchronizer clutch 171 are arranged coaxially with and coupled to the fourth rotatable shaft 163. In some embodiments, the first synchronizer clutch 168 and the third synchronizer clutch 170 are operably coupled to the first-and-third mode clutch 160. The second synchronizer clutch 169 and the fourth synchronizer clutch 171 are operably coupled to the second-and-fourth mode clutch 161.

Still referring to FIG. 13, in some embodiments, the CVT 150 includes a second planetary gear set 172 having a second ring gear 173, a second planet carrier 174, and a second sun gear 175. In some embodiments, the second planetary gear set 172 is optionally configured as a dual pinion gear set. For example, the second planet carrier 174 supports two arrays of planet gears to the second ring gear 173 and the second sun gear 175. In some embodiments, the second sun gear 175 is a hollow sun gear to thereby allow passage of other shafts there through. In some embodiments, the second planet carrier 174 is grounded to a non-rotatable member of the CVT 150. The second planetary gear set 172 is coaxial with a fifth rotatable shaft 176. The fifth rotatable shaft 176 is parallel with the main axis and the third rotatable shaft 162. The fifth rotatable shaft 176 is coupled to the second sun gear 175. In some embodiments, the fifth rotatable shaft 176 is optionally configured as a hollow shaft. In some embodiments, the reverse-mode gear set 166 is configured to couple to the fifth rotatable shaft 176. The CVT 150 includes a first-mode gear set 177 coupled to the first synchronizer clutch 168 and the fifth rotatable shaft 176. The CVT 150 includes a second-mode gear set 178 coupled to the second synchronizer clutch 169 and the fifth rotatable shaft 176. The CVT 150 includes a third-mode gear set 179 coupled to the third synchronizer clutch 170 and the fifth rotatable shaft 176. The CVT 150 includes a fourth-mode gear set 180 coupled to the fourth synchronizer clutch 171 and the fifth rotatable shaft 176. In some embodiments, the second ring gear 173 is coupled to a final drive gear 181. The final drive gear 181 is optionally configured as a typical differential gear.

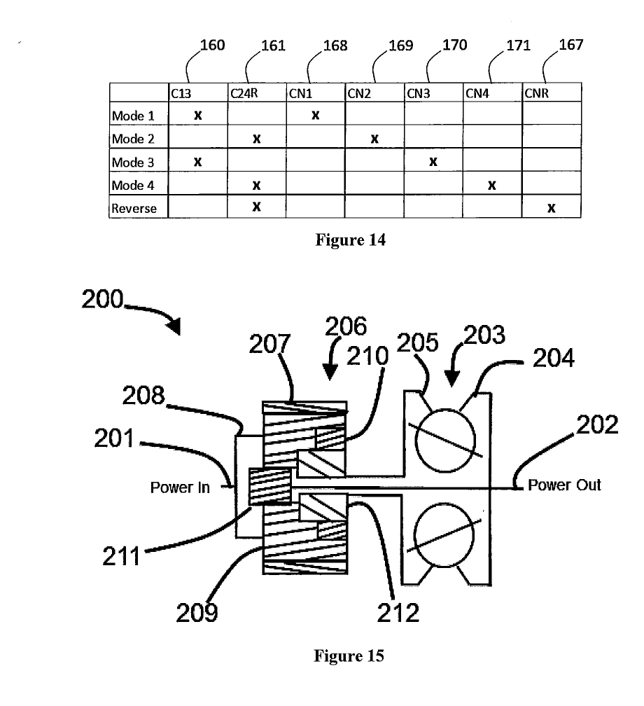

Referring now to FIG. 14, during operation of the CVT 150 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVT 150. The table depicted in FIG. 14, lists the modes of operation for the CVT 150 and indicates with an “x” the corresponding clutch engagement. For mode 1 operation, the first-and-third mode clutch 160 and the first synchronizer clutch 168 are engaged. For mode 2 operation, the second-and-fourth mode clutch 161 and the second synchronizer clutch 169 are engaged. For mode 3 operation, the first-and-third mode clutch 160 and the third synchronizer clutch 170 are engaged. For mode 4 operation, the second-and-fourth mode clutch 161 and the fourth synchronizer clutch 171 are engaged. For reverse mode operation, the second-and-fourth mode clutch 161 and the reverse clutch 167 are engaged.

Referring now to FIG. 15, in some embodiments, in some embodiments a powersplit continuously variable transmission 200 is provided with a first rotatable shaft 201 adapted to receive power from a source of rotational power. In some embodiments, the CVT 200 has a second rotatable shaft 202 coaxial with the first rotatable shaft 201. The first rotatable shaft 201 and the second rotatable shaft 202 form a main axis of the CVT 200. The CVT 200 has a variator assembly 203 arranged coaxial with the main axis. In some embodiments, the variator assembly 203 is configured to be a CVP of the type depicted in FIGS. 1-3. In some embodiments, the variator assembly 203 has a first traction ring assembly 204 and a second traction ring assembly 205 in contact with an array of balls. In some embodiments, the CVT 200 is provided with a ravigneaux gear set 206 having a ring gear 207, a pinion carrier 208, an array of long pinions 209 coupled to the ring gear 207 and the pinion carrier 208, an array of short pinions 210 coupled to the pinion carrier 208, a first sun gear 211 coupled to the array of long pinions 209, and a second sun gear 212 coupled to the array of short pinions 210. In some embodiments, the pinion carrier 208 is operably coupled to the first rotatable shaft 201. In some embodiments, the first sun gear 211 is coupled to the second rotatable shaft 202 and the first traction ring assembly 204. In some embodiments, the second sun gear 212 is coupled to the second traction ring assembly 205. It should be appreciated that the CVT 200 is optionally implemented in the CVT 10 in place of the variator assembly 12 and the first planetary gear set 15.

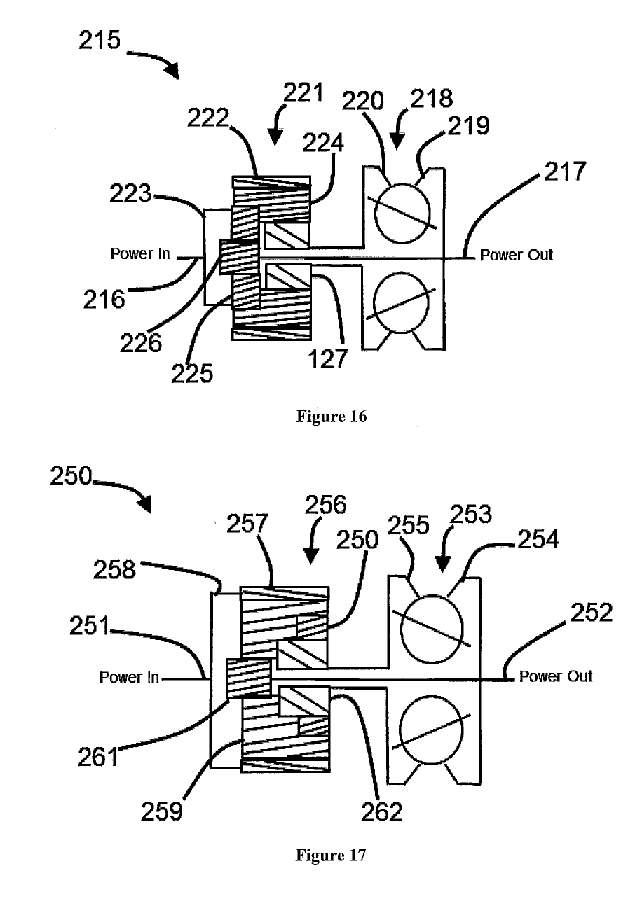

Turning now to FIG. 16, in some embodiments, in some embodiments a powersplit continuously variable transmission 215 is provided with a first rotatable shaft 216 adapted to receive power from a source of rotational power. In some embodiments, the CVT 215 has a second rotatable shaft 217 coaxial with the first rotatable shaft 216. The first rotatable shaft 216 and the second rotatable shaft 217 form a main axis of the CVT 215. The CVT 215 has a variator assembly 218 arranged coaxial with the main axis. In some embodiments, the variator assembly 218 is configured to be a CVP of the type depicted in FIGS. 1-3. In some embodiments, the variator assembly 218 has a first traction ring assembly 219 and a second traction ring assembly 220 in contact with an array of balls. In some embodiments, the CVT 215 is provided with a ravigneaux gear set 221 having a ring gear 222, a pinion carrier 223, an array of long pinions 224 coupled to the ring gear 222 and the pinion carrier 223, an array of short pinions 225 coupled to the pinion carrier 223, a first sun gear 226 coupled to the array of short pinions 225, and a second sun gear 227 coupled to the array of long pinions 224. In some embodiments, the pinion carrier 223 is operably coupled to the first rotatable shaft 216. In some embodiments, the first sun gear 226 is coupled to the second rotatable shaft 217 and the first traction ring assembly 219. In some embodiments, the second sun gear 227 is coupled to the second traction ring assembly 220. It should be appreciated that the CVT 215 is optionally implemented in the CVT 10 in place of the variator assembly 12 and the first planetary gear set 15.

Referring now to FIG. 17, in some embodiments, in some embodiments a powersplit continuously variable transmission 250 is provided with a first rotatable shaft 251 adapted to receive power from a source of rotational power. In some embodiments, the CVT 250 has a second rotatable shaft 252 coaxial with the first rotatable shaft 251. The first rotatable shaft 251 and the second rotatable shaft 252 form a main axis of the CVT 250. The CVT 250 has a variator assembly 253 arranged coaxial with the main axis. In some embodiments, the variator assembly 253 is configured to be a CVP of the type depicted in FIGS. 1-3. In some embodiments, the variator assembly 253 has a first traction ring assembly 254 and a second traction ring assembly 255 in contact with an array of balls. In some embodiments, the CVT 250 is provided with a ravigneaux gear set 256 having a ring gear 257, a pinion carrier 258, an array of long pinions 259 coupled to the ring gear 257 and the pinion carrier 258, an array of short pinions 260 coupled to the pinion carrier 258, a first sun gear 261 coupled to the array of long pinions 259, and a second sun gear 262 coupled to the array of short pinions 260. In some embodiments, the ring gear 257 is operably coupled to the first rotatable shaft 251. In some embodiments, the first sun gear 261 is coupled to the second rotatable shaft 252 and the first traction ring assembly 254. In some embodiments, the second sun gear 262 is coupled to the second traction ring assembly 255. It should be appreciated that the CVT 250 is optionally implemented in the CVT 10 in place of the variator assembly 12 and the first planetary gear set 15.

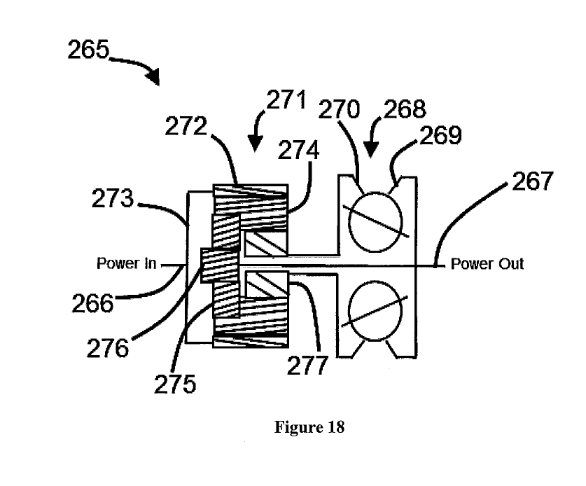

Turning now to FIG. 18, in some embodiments, in some embodiments a powersplit continuously variable transmission 265 is provided with a first rotatable shaft 266 adapted to receive power from a source of rotational power. In some embodiments, the CVT 265 has a second rotatable shaft 267 coaxial with the first rotatable shaft 266. The first rotatable shaft 266 and the second rotatable shaft 267 form a main axis of the CVT 265. The CVT 265 has a variator assembly 268 arranged coaxial with the main axis. In some embodiments, the variator assembly 268 is configured to be a CVP of the type depicted in FIGS. 1-3. In some embodiments, the variator assembly 268 has a first traction ring assembly 269 and a second traction ring assembly 270 in contact with an array of balls. In some embodiments, the CVT 265 is provided with a ravigneaux gear set 271 having a ring gear 272, a pinion carrier 273, an array of long pinions 274 coupled to the ring gear 272 and the pinion carrier 273, an array of short pinions 275 coupled to the pinion carrier 273, a first sun gear 276 coupled to the array of short pinions 275, and a second sun gear 277 coupled to the array of long pinions 274. In some embodiments, the ring gear 272 is operably coupled to the first rotatable shaft 266. In some embodiments, the first sun gear 276 is coupled to the second rotatable shaft 267 and the first traction ring assembly 269. In some embodiments, the second sun gear 277 is coupled to the second traction ring assembly 270. It should be appreciated that the CVT 265 is optionally implemented in the CVT 10 in place of the variator assembly 12 and the first planetary gear set 15.

Further provided herein is a vehicle driveline including a power source, a variable transmission of any of described herein drivingly engaged with the power source, and a vehicle output drivingly engaged with the variable transmission. In some embodiments of the vehicle driveline, the power source is drivingly engaged with the vehicle output.

Further provided herein is a vehicle including the variable transmission of any one of the transmissions described herein.

Further provided herein is a method including providing a variable transmission of any one of the transmissions described herein.

Further provided herein is a method including providing a vehicle driveline of the kind described herein.

Further provided herein is a method including providing a vehicle having any one of the transmission described herein.

Provided herein is a method of operating a continuously variable transmission, the method including: providing a continuously variable transmission including: a first rotatable shaft operably coupleable to a source of rotational power; a second rotatable shaft coaxial with the first rotatable shaft, the first rotatable shaft and the second rotatable shaft forming a main axis; a third rotatable shaft aligned parallel to the main axis; a fourth rotatable shaft aligned parallel to the main axis and the third rotatable shaft; a variator assembly having a first traction ring assembly and a second traction ring assembly in contact with a first plurality of balls, wherein each ball of the first plurality of balls has a tiltable axis of rotation, the variator assembly is coaxial with the main axis; a first planetary gearset having a first sun gear, a first planet carrier operably coupled to the first rotatable shaft, and a first ring gear coupled to the second traction ring assembly; a first gear set operably coupled to the first traction ring assembly, the first gear set coupled to the third rotatable shaft; a second gear set operably coupled to the first sun gear, the second gear set operably coupled to the third rotatable shaft; a third gear set operably coupled to the second traction ring assembly, the third gear set coupled to the fourth rotatable shaft; a first-and-third mode clutch coaxial with, and coupled to, the second rotatable shaft; a second-and-third mode clutch coaxial with, and coupled to, the second rotatable shaft; a first synchronizer clutch operably coupled to the fourth rotatable shaft and the first-and-third mode clutch; a second synchronizer clutch operably coupled the third rotatable shaft and the second-and-fourth mode clutch; a third synchronizer clutch operably coupled to the fourth rotatable shaft and the first-and-third mode clutch; and a fourth synchronizer clutch operably coupled to the third rotatable shaft and the second-and-fourth mode clutch; engaging the first-and-third mode clutch to operate in a first mode of operation and a third mode of operation; engaging the second-and-fourth mode clutch to operate in a second mode of operation and a fourth mode of operation.

Provided herein is a method of operating a continuously variable transmission, the method including providing a continuously variable transmission including a first rotatable shaft operably coupleable to a source of rotational power; a second rotatable shaft coaxial with the first rotatable shaft, the first rotatable shaft and the second rotatable shaft forming a main axis; a third rotatable shaft aligned parallel to the main axis; a fourth rotatable shaft aligned parallel to the main axis and the third rotatable shaft; a fifth rotatable shaft aligned parallel to the main axis and the third rotatable shaft; a variator assembly having a first traction ring assembly and a second traction ring assembly in contact with a plurality of balls, wherein each ball of the plurality of balls has a tiltable axis of rotation, the variator assembly is coaxial with the main axis; a first planetary gearset having a first sun gear, a first planet carrier operably coupled to the first rotatable shaft, and a first ring gear coupled to the second traction ring assembly; a first-and-third mode clutch coaxial with, and coupled to, the third rotatable shaft; a second-and-fourth mode clutch coaxial with the third rotatable shaft; a first gear set operably coupled to the second traction ring assembly, the first gear set coupled to the first-and-third mode clutch; a second gear set operably coupled to the first traction ring assembly, the second gear set operably coupled to the second-and-fourth mode clutch, the second gear set coupled to the fourth rotatable shaft; a first synchronizer clutch operably coupled to the third rotatable shaft and the first-and-third mode clutch; a second synchronizer clutch arranged coaxially with the third rotatable shaft, the second synchronizer clutch coupled to the second-and-fourth mode clutch; a third synchronizer clutch operably coupled to the third rotatable shaft and the first-and-third mode clutch; and a fourth synchronizer clutch arranged coaxially with the third rotatable shaft, the fourth synchronizer clutch coupled to the second-and-fourth mode clutch; engaging the first-and-third mode clutch to operate in a first mode of operation and a third mode of operation; and engaging the second-and-fourth mode clutch to operate in a second mode of operation and a fourth mode of operation.

It should be noted that the description above has provided dimensions for certain components or subassemblies. The mentioned dimensions, or ranges of dimensions, are provided in order to comply as best as possible with certain legal requirements, such as best mode. However, the scope of the preferred embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the preferred embodiments. It is intended that the following claims define the scope of the preferred embodiments and that methods and structures within the scope of these claims and their equivalents be covered thereby.

What is claimed is:

1. A continuously variable transmission comprising:
a first rotatable shaft operably coupleable to a source of rotational power, the first rotatable shaft forming a main axis;
a variator assembly having a first traction ring assembly and a second traction ring assembly in contact with a plurality of balls, wherein each ball of the plurality of balls has a tiltable axis of rotation, the variator assembly is coaxial with the main axis;
a first planetary gearset having a first sun gear, a first planet carrier operably coupled to the first rotatable shaft, and a first ring gear coupled to the second traction ring assembly;
a first gear set operably coupled to the first traction ring assembly;
a second gear set operably coupled to the first sun gear, the second gear set operably coupled to the first gear set; and
a third gear set operably coupled to the second traction ring assembly.

2. The continuously variable transmission of claim 1, further comprising a first coupling device operably coupled to the first gear set, the first coupling device configured to provide a first power output path.

3. The continuously variable transmission of claim 2, further comprising a second coupling device operably coupled to the second gear set, the second coupling device configured to provide a second power output path.

4. The continuously variable transmission of claim 3, further comprising a third coupling device operably coupled to the third gear set, the third coupling device configured to provide a third power output path.

5. The continuously variable transmission of claim 4, further comprising a coupling planetary device having a second ring gear, a second planet carrier, and a second sun gear, the coupling planetary device operably coupled to the first coupling device.

6. The continuously variable transmission of claim 4, further comprising a coupling planetary device having a second ring gear, a second planet carrier, and a second sun gear, the coupling planetary device operably coupled to the second coupling device.

7. The continuously variable transmission of claim 4, further comprising a coupling planetary device having a second ring gear, a second planet carrier, and a second sun gear, the coupling planetary device operably coupled to the third coupling device.

8. The continuously variable transmission of claim 5, wherein the coupling planetary device is operably coupled to the second coupling device.

9. The continuously variable transmission of claim 5, wherein the coupling planetary device is operably coupled to the third coupling device.

10. The continuously variable transmission of claim 6, wherein the coupling planetary device is operably coupled to the third coupling device.

11. The continuously variable transmission of claim 10, wherein the coupling planetary device is operably coupled to the first coupling device.

12. The continuously variable transmission of claim 5, wherein the second planet carrier is grounded.

13. The continuously variable transmission of claim 5, wherein the second planet carrier is adapted to spin freely without transmitting rotational power.

14. The continuously variable transmission of claim 12, wherein the second sun gear is grounded.

15. The continuously variable transmission of claim 12, wherein the second sun gear is adapted to spin freely without transmitting rotational power.

16. The continuously variable transmission of claim 13, wherein the second sun gear is grounded.

17. The continuously variable transmission of claim 13, wherein the second sun gear is adapted to spin freely without transmitting rotational power.

18. The continuously variable transmission of claim 5, wherein the second ring gear is coupled to the first coupling device.

19. The continuously variable transmission of claim 5, wherein the second ring gear is coupled to the second coupling device.

20. The continuously variable transmission of claim 5, wherein the second ring gear is coupled to the third coupling device.
